(19) United States
(12) Patent Application Publication
(10) Pub. No.: US 2004/0156955 A1
(43) Pub. Date: Aug. 12, 2004

(54) Candy sucker

(76) Inventor: William L. Klima, Stafford, VA (US)

Correspondence Address: WILLIAM L. KLIMA, A PROFESSIONAL LAW CORPORATION, 2046-C JEFFERSON DAVIS HIGHWAY, STAFFORD, VA, 22554, US

(21) Appl. No.: 10/364,312

(22) Filed: Feb. 11, 2003

(51) Int. Cl. A23G 1/00

(52) U.S. Cl. 426/104

(57) ABSTRACT

The present invention is directed to a candy sucker article. Specifically, the candy sucker article includes a manually rotatable candy sucker in combination with a container.

### FIELD OF THE INVENTION

The present invention is directed to a candy sucker, in particular to a candy sucker article.

### BACKGROUND OF THE INVENTION

There exists a product known as the Spin Pop™ that includes a lollipop connected to a handle configured to rotate the lollipop. The handle is provided with a battery operated motor connected to a rotatable spindle configured to releasably connect with the stick portion of the lollipop. The handle is provided with a push button for activating the battery operated motor for spinning the lollipop.

The Spin pop™ is relatively expensive to manufacture and sell as a candy product. Further, the lollipop is quickly consumed, or batteries wear down with use or time, and then the Spin Pop™ becomes non-functional and is then disposed of by the user.

Thus, there exists a need for new and different products related to the Spin Pop™.

### SUMMARY OF THE INVENTION

A first object of the present invention is to provide an improved candy sucker article.

A second object of the present invention is to provide an improved candy sucker article including a rotatable candy sucker in combination with a container.

A third object of the present invention is to provide a candy sucker article including a manually rotatable candy sucker in combination with a container.

A fourth object of the present invention is to provide a candy sucker article, including a rotatable candy sucker in combination with a container, the container including a compartment configured to allow the rotatable candy sucker to be selectively accessible when the container is open.

A fifth object of the present invention is to provide a candy sucker article including a container in combination with a candy sucker configured to be rotatable relative to the container by a manually operated mechanism.

The present invention is directed to an improved candy sucker article. Specifically, the candy sucker article according to the present invention includes the combination of a rotatable candy sucker and container. The rotatable candy sucker is preferably manually rotated, manually driven, and/or manually actuated.

The present invention is also directed to the concept of a candy sucker in combination with a container having a compartment for storing the candy sucker, which compartment is accessible when the container is opened. For example, a closure of the container covers the compartment of the container, and when the closure is opened the candy sucker stored in the compartment is then accessible.

The candy sucker used in the article according to the present invention can take on various forms. Specifically, the candy sucker, for example, can be a hard candy sucker like a lollipop having a hard candy portion connected to a stick portion, can be a separate piece of hard candy that can be connected to another portion of the article (e.g. to be spun thereby), or a hard candy piece mechanically connected to the another portion of the article (e.g. molded over a plastic nipple or protrusion of the container or lid).

The candy sucker can be connected to one or more components of the article such as the container and/or closure, or can be a separate item associated with the article. Specifically, the candy sucker can be packaged (e.g. in a container, shrink wrapped, wrapped) together with the container having a closure. Further, the candy sucker can be packaged within the container and/or closure. For example, the candy sucker can be stored within the container, then removed and connected to a rotatable portion of the article.

The present invention is directed to a candy sucker including the combination of a container and a candy sucker configured to rotate relative to the container. In a preferred embodiment, the candy sucker is disposed within the container and the candy sucker is configured to rotate within the container. In a more preferred embodiment, the candy sucker both rotates within the container and is configured to extend from the container or be removed from the container to provide better access to a person either licking the candy sucker or placing the candy sucker in the person's mouth. The candy sucker can be configured to be directly manipulated to rotate (e.g. by using a person's finger tips), or can be configured to be indirectly rotated (e.g. by using a manual drive mechanism).

In another preferred embodiment, the candy sucker is stored outside the container, however, the candy sucker article includes a rotating device connected to the candy sucker and configured to rotate the candy sucker. Again, the rotating device is preferably manually operated (e.g. manipulate by fingers and/or hands) to eliminated the need for batteries, can be configured to generate or store energy (e.g. spring loaded device, wind up device, top, gyro, solar powered, battery powered, wind powered) to cause rotation, and preferably selectively actuated (e.g. by push button or slide switch).

The present invention is also directed to a candy sucker article having the combination of a container, a rotatable candy sucker, and a light emitting device. The light emitting device can be, for example, a battery operated device or non-battery device energy source such as a small wind up electrical generator, or can be generated by phospho-luminescence (e.g. two part solution breakable light stick incorporated within article).

The present invention is also direct to a candy sucker article having the combination of a container, a rotatable candy sucker, and a noise generating device. A battery operated device or mechanically generated noise maker (e.g. whistle, rattle, wind up mechanical siren, wind up noise generator) can be utilized.

There exists numerous other embodiments or combinations of the present invention. For example, a candy sucker article according to the present invention can include the combination of a container, a rotatable candy sucker, a mechanism or device for rotating the candy sucker, a light emitting device and/or noise generating device. In any event, the present invention is directed to numerous embodiments of these and other features and elements described herein.

### BRIEF DESCRIPTION OF THE DRAWINGS

FIG. 1 is a perspective view of an embodiment of the candy sucker device according to the present invention with a rotatable candy sucker disposed within the container in a closed position.

FIG. 2 is a perspective view of an embodiment of the candy sucker device according to the present invention with the rotating candy sucker disposed within the container in an open position.

FIG. 3 is a perspective view of an embodiment of the candy sucker device according to the present invention with a rotating stick-shaped candy sucker located within a container.

FIG. 4 is a perspective view of the candy sucker article shown in FIG. 3 with the candy sucker extended therefrom.

FIG. 5 is a perspective view of an embodiment of the candy sucker article according to the present invention with a rotatable stick-shaped candy sucker located within the container.

FIG. 6 is a perspective view of the candy sucker article shown in FIG. 5 with the candy sucker extended therefrom.

FIG. 7 is a perspective view of a candy sucker device according to the present invention with a drill type device connected to a rotatable lollipop connected to an upper portion of the container.

FIG. 8 is a perspective view of a candy sucker article according to the present invention with a drill type mechanism configured for rotating a candy sucker.

FIG. 9 is a perspective view of a candy sucker article according to the present invention with a rotatable lollipop disposed within a container.

FIG. 10 is a perspective view of a candy sucker article according to the present invention with a lollipop rotatably disposed within a container.

FIG. 11 is a perspective view of a candy sucker article according to the present invention with a lollipop rotatably disposed within a container.

FIG. 12 is a perspective view of a candy sucker article according to the present invention with a lollipop provided with a handle disposed within a bag type container.

FIG. 13 is a partial broken away cross-sectional view of the lollipop handle of the candy sucker article shown in FIG. 12.

FIG. 14 is a perspective view of a candy sucker article according to the present invention including a vibrating a handle connected to a candy sucker disposed within an upper container portion.

FIG. 15 is a perspective view of a candy sucker article according to the present invention configured to rotate and extend a candy sucker.

FIG. 16 is a perspective view of a candy sucker article according to the present invention with a rotatable stick-shaped lollipop having a handle portion inserted through a hole in an upper portion of a container.

FIG. 17 is a perspective view of the candy sucker article shown in FIG. 16 with the stick-shaped sucker removed from the container.

FIG. 18 is a perspective view of a candy sucker article according to the present invention having a rotatable candy sucker.

FIG. 19 is a perspective view of a candy sucker device according to the present having a rotatable candy sucker.

FIG. 20 is a perspective view of a candy sucker article according to the present invention having a rotatable candy sucker.

FIG. 21 is a perspective view of a candy sucker article according to the present invention having a rotatable candy sucker.

FIG. 22 is a perspective view of a candy sucker article according to the present invention configured to spin a lollipop.

FIG. 23 is a perspective view of a candy sucker article according to the present invention configured to simulate a drill.

FIG. 24 is a perspective view of a candy sucker article according to the present invention configured to spin a candy sucker.

FIG. 25 is a vertical center cross-sectional view of the candy sucker article shown in FIG. 24.

FIG. 26 is a perspective view of a candy sucker article according to the present invention configured to spin a lollipop within a container.

FIG. 27 is a perspective view of a candy sucker article according to the present invention configured with a gyro to spin a lollipop within a container.

FIG. 28 is a perspective view of a candy sucker article according to the present invention provided with a lid configured to rotate a candy sucker within a container.

FIG. 29 is a perspective view of a candy sucker article according to the present invention provided with a removable handle configured to spin a lollipop by pushing a button on the lid downwardly.

FIG. 30 is a perspective view of a candy sucker article according to the present invention having an upper lid and a rotatable hard candy sucker.

FIG. 31 is perspective view of a candy sucker article with a mechanism configured to spin a lollipop by pressing a button.

### DETAILED DESCRIPTION OF PREFERRED EMBODIMENTS

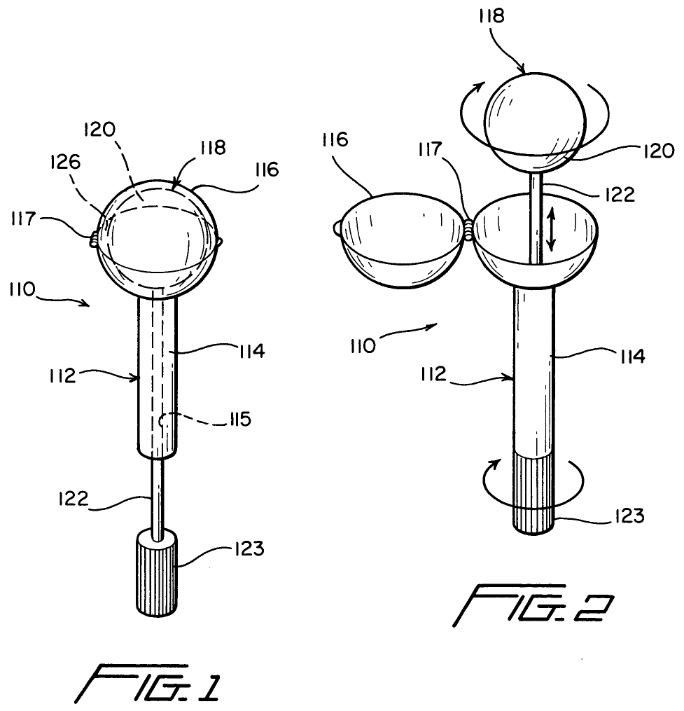

An embodiment of a candy sucker article 110 according to the present invention is shown in FIGS. 1 and 2.

The candy sucker article 110 includes a container 112 having a lower container portion 114 connected to an upper container portion 116 by a hinge 117. Preferably the container 112 is made of plastic injection molded parts. For example, the upper container portion 116 can be a clear or translucent plastic injection molded part to allow a person to view the lollipop 118 stored therein. Further, the lower container portion 114 can be an opaque plastic injection molded part or clear or translucent. In embodiments utilizing clear plastic material, the plastic material can be colored, colorless and/or tinted to provide various visual effects and appearances.

A grip 123 (e.g. fingergrip or finger and thumb grip) is connected to a lower end of the stick portion 122 of the lollipop 118. Specifically, the container 112 is provided with a through passageway 115 for accommodating the stick portion 122 of the lollipop 118, and to allow both sliding of the stick portion 122 upwardly and downwardly and rotating movement within the container 112 as indicated in FIG. 2.

In use, a person grips the lower container portion 114 with the fingers and thumb of one hand, and grabs the grip 123 with the fingers and thumb of the other hand. The person then pushes upwardly on the grip 123 while holding the lower container portion 114 stationary causing the lollipop 118 to raise and open the upper container portion or lid 116 to the position shown in FIG. 2. The person licks the lollipop 118, and then lowers the lollipop back into the lower container portion 114 for storage thereof. The person then again raises the lollipop 118 from within the container 112 to provide access for again licking. The uppercontainer portion 116 can be spring loaded to automatically open and close with movement of the lollipop 118 upwardly and downwardly relative to the container 112. Alternatively, the upper container portion or lid 116 can be freely hinged to open and close by gripping with the finger and thumb of a person using the candy sucker article 110. Preferably, the upper container portion 116 can positively connect or lock with the lower container portion 114 in the “closed” position (e.g. by providing an interference fit or snap-fit connection).

Another embodiment of the candy sucker article 210 according to the present invention is shown in FIGS. 3 and 4.

The candy sucker article 210 includes a container 212 having a lower container portion 214 and a removable upper container portion or lid 216. For example, the removable lid 216 can be a removable snap cap or twist on/off closure. A hard candy sucker 220 is disposed within the container 212 and is connected to grip 223. Specifically, the grip 223 includes a shaft portion 223a connected to a sleeve portion 223b configured to receive a lower end of the candy sucker 220 therein. The grip 223 and the candy sucker 220 are configured to both slidably move upwardly and downwardly and rotate within a through passageway 215 of the container 212.

During use, a person removes the lid 216 and presses upwardly on the grip 223 while holding stationary the container 212. The candy sucker 220 extends from the top of the container 212, as shown in FIG. 4, to allow a person to lick a top portion of the candy sucker 220. The person then lowers the upper end of the candy sucker 220 back into the container 212 by pulling downwardly on the grip 223. The person then pushes upwardly on the grip 223 to again raise and extend the upper portion of the candy sucker 220 out of the container 212 to allow further licking.

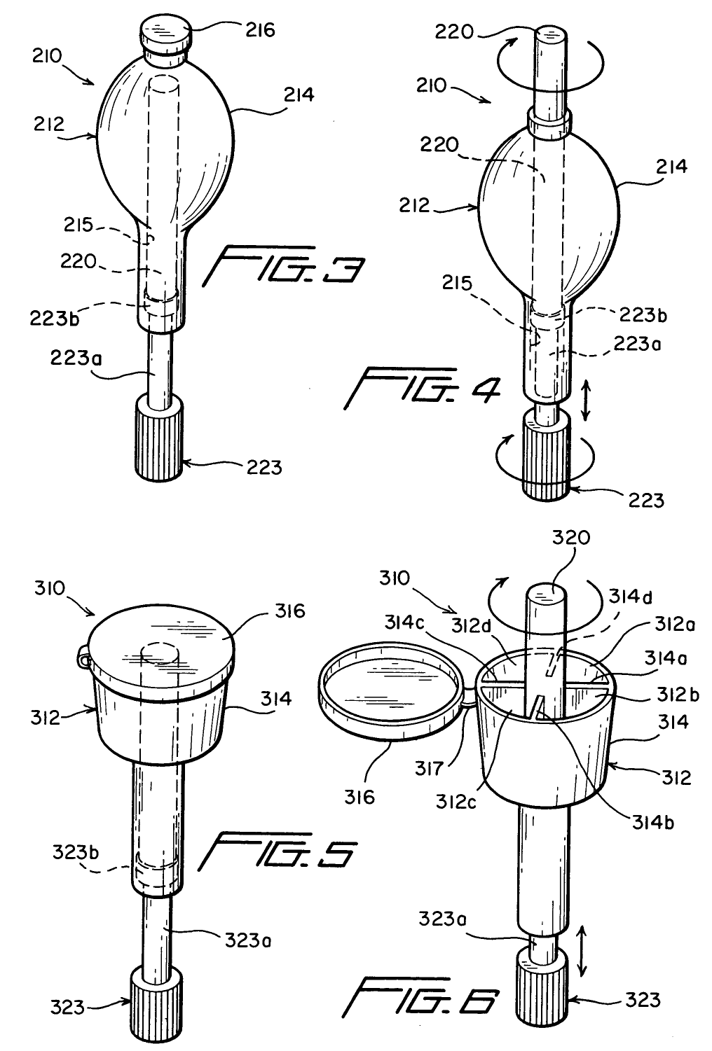

Another embodiment of the candy sucker article 1910 according to the present invention is shown in FIGS. 5 and 6.

The candy sucker article 310 includes a container 312 having a lower container portion 314 connected to an upper container portion or lid 316 by a live hinge 317, as shown in FIG. 6. The container 312 is a multiple chamber container having four (4) separate chambers 312a, 312b, 312c and 312d. The candy sucker 320 is shown as being cylindrically-shaped, and extends through the middle of the container 312. The inside of the container 312 is provided with four (4) separate flanges 314a-d that extend radially inwardly and end at the cylindrical-shaped surface of the candy sucker 320.

In use, a person pushes upwardly the grip 323 while holding the container 312 stationary forcing the lid 316 upwardly with the end of the candy sucker 320. The person then licks the upper end of the candy sucker 320, and lowers the candy 1920 back into the container 312 by pulling downwardly on the grip 323. The person then pushes upwardly on the grip 323 to again raise the candy sucker 320 out of the container 312 to allow further licking thereof.

Another embodiment of the candy sucker article 410 is shown in FIG. 7.

The candy sucker article 410 includes a container 412 having a lower container portion 414 and an upper container portion or lid 416. The lid 416 is removable from the lower container portion 414. A rotating device 460 is removably connected to the lid 416 of the container 412, and extends upwardly therefrom. Specifically, the lid 416 is provided with a sleeve 416a having an aperture 416b configured to receive the lower end of the handle 462 of the rotating device.

The rotating device 460 includes a rotating spindle 464 having an aperture 466 configured to connect with a lollipop 418. Specifically, the lollipop 418 includes a hard candy portion 420 connected on an end of a stick portion 422. The lower end of the stick portion 422 is received within the aperture 466 of the rotating spindle 464. The rotating device 460 includes a crank 468 having a fingergrip 470. The crank 468 is configured to rotate the spindle 464. For example, the crank 468 can be provided with an internal bevel gear cooperating with another internal bevel gear connected to the spindle 464. In this manner, when the fingergrip 470 is rotated as indicated, the spindle 464 turns the lollipop 418 as shown.

In use, the rotating device 460 is operated to turn the hard candy portion 420 of the lollipop 4018 to rotate the lollipop 418 while the person licks same.

Another embodiment of the candy sucker article 510 is shown in FIG. 8.

The candy sucker article 510 includes a container 512 having a lower container portion 514 and an upper container portion or lid 516. The lid 516 is removable from the lower container portion 514. A rotating device 560 is connected to an upper portion of the lid 516.

A hard candy sucker 520 having a helical groove 520a provided in an outer surface thereof is disposed within the rotating device 560. The rotating device 560 includes a crank 568 having a fingergrip 570. The crank 568 is configured for rotating the candy sucker 520 within the rotating device 560. For example, the crank 568 can be connected to a set of gears and a fictional wheel for engaging an outer surface of the candy sucker 520 to rotate same within the rotating device 560.

In use, a person rotates the crank 568 with his or her finger and thumb turning the hard candy sucker 520 in the direction indicated, which can then be licked by the person.

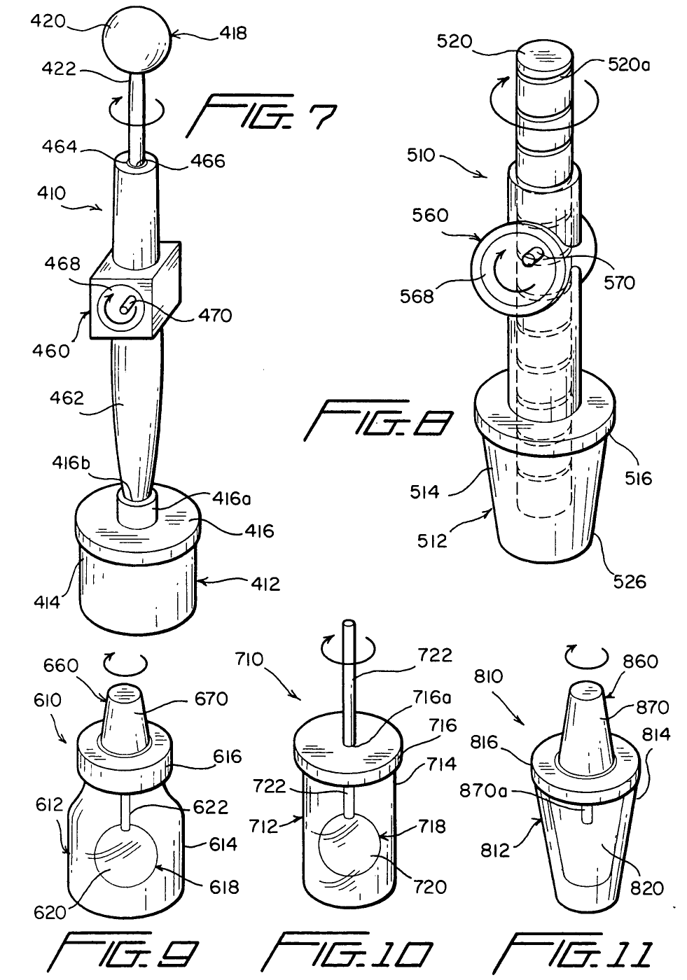

Another embodiment of the candy sucker article 610 according to the present invention is shown in FIG. 9.

The candy sucker article 610 includes a container 612 having a lower container portion 614 and an upper container portion or lid 616. The lid 616 is removable from the lower container portion 614, for example, by a snapfit connection or threaded connection. The lid 616 is provided with a rotating device 660. Specifically, the rotating device 660 includes a rotatable fingergrip 670 configured to spin relative to the lid 616. A lollipop 618 including a hard candy portion 620 and a stick portion 622 is disposed within the lower container portion 614. An upper end of the stick portion 622 is connected to the rotatable fingergrip 670 to allow a person to spin the lollipop 618 when the container 612 is closed and the lollipop is disposed therein.

In use, a person removes the lid 616 along with the lollipop 618 from the container 612. The person then licks the lollipop 618 and inserts the lollipop 618 into the container 612 and rotates the lollipop 618 by twisting the fingergrip 670. A person again removes the lollipop 618 from the container 612 and licks the lollipop 618.

Another embodiment of the candy sucker article 710 according to the present invention is shown in FIG. 10.

The candy sucker article 710 includes a container 712 having a lower container portion 714 connected to an upper container portion or lid 716. The lid 716 is removable from the lower container portion 714, for example, by a snapfit connection or threaded connection. A lollipop 718 is disposed within the container 712. Specifically, the hard candy portion 720 of the lollipop 718 is located within the container 712 and a stick portion 722 extends through a hole or aperture 716a of the lid 716. The candy sucker article 710 is configured so that the lollipop 718 can be rotated within the container 712 by gripping the stick portion 722 between the thumb and finger and twisting same.

In use, a person removes the lid 716 along with the lollipop 718 from the container 712. Then the person licks the outer surface of the hard candy portion 720 of the lollipop 718, and then places the hard candy portion 720 of the lollipop 718 into the container 712. A person then removes the lollipop 718 by removing the lid 716 from the container 720 and licks the lollipop.

Another embodiment of the candy sucker article 810 according to the present invention is shown in FIG. 11.

The candy sucker article 810 includes a container 812 having a lower container portion 814 and an upper container portion or lid 816. The lid 816 is removable from the lower container portion 814, for example, by a snapfit connection or threaded connection. The lid 816 is provided with a rotating device 860 configured for rotating a candy sucker 820 within the container 812. Specifically, the rotating device 860 includes a fingergrip 870 configured to connect with the lid 816 and rotate relative thereof. The fingergrip 870 includes a downwardly extending protrusion configured to connect with the candy sucker 820. For example, the candy sucker 820 can be molded onto the bottom of the fingergrip 820 so that the protrusion 870a is embedded within the candy sucker 820.

In use, a person removes the lid 816 from the container 812 and licks the outer surface of the candy sucker 820. The person then removes the candy sucker 820 from the container 812 and licks the outer surface thereof

Another embodiment of the candy sucker article 910 according to the present invention is shown in FIG. 12.

The candy sucker article 910 includes a container 912 (e.g. flexible container, bag, plastic bag, wrapper, plastic wrapper, pouch, etc.) containing a lollipop 918. For example, the container 912 can be a clear saran wrap material formed in a continuous wrapper material, cut and heat sealed at opposite ends to seal the lollipop 918. The lollipop 918 includes a hard candy portion 920 connected to a stick portion 922. A rotating device 960 is connected to the free,end of the lollipop stick portion 922. As shown in FIG. 13, the rotating device 960 can be a plastic injection molded part having an aperture 966 configured to connect with the free end of the lollipop stick 922. The rotating device 960 includes a fingergrip 970 (e.g. configured to fit between forefinger and thumb), and configured to allow a person to twist the lollipop using the fingergrip 970.

In use, a person opens the container 912, by tearing at the precut 972 to allow tearing traversely along the width of the container 912. The person then removes the lollipop 918 by use of the fingergrip 970, licks the outer surface of the lollipop 918. The person withdraws the lollipop 918 from the container 912, and then licks the lollipop 918.

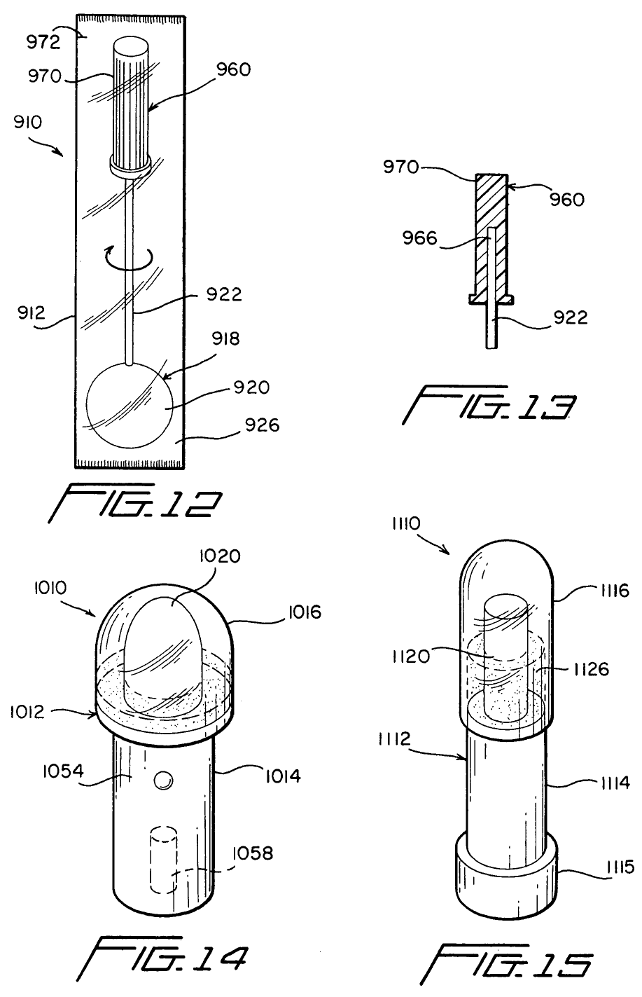

Another candy sucker article device 1010 according to the present invention is shown in FIG. 14.

The candy sucker article 1010 includes a container 1012 having a lower container portion 1014 configured to be a handle, and an upper housing portion or lid 1016 to be configured as a dome, preferably a see-through dome. The lower container portion 1014 includes a battery operated or manually operated spring wind up mechanical vibrator 1058 and a push button switch 1054 configured to actuate the vibrator 1058 configured to vibrate the candy sucker article 1010. A candy sucker 1020 is connected to the lower container portion 1014 and extends upwardly within the dome-shaped lid 1016.

In use, a person separates the upper container portion 1016 from the lower container portion 1014. The person then licks the outer surface of the candy sucker 1020. The push button switch 2954 is activated to vibrate the candy sucker 2920 when licking.

Another embodiment of the candy sucker article 1110 according to the present invention is shown in FIG. 15.

The candy sucker article 1110 includes a container 1112 having a lower container portion 1114 connected to an upper container portion 1116. Preferably, the upper dome-shaped container 1116 is see-through, and removable from the lower container portion 1114. The lower container portion 1114 includes a rotatable fingergrip 1115 configured to extend or retract the candy sucker 1120 from or into the lower container portion 1112. For example, the rotatable fingergrip 1115 can include a threaded protrusion extending upwardly cooperating with a threaded sleeve coupled to the lower end of the candy sucker 1120. Otherwise a manually operated mechanism similar to a compact lipstick can be utilized for driving the candy sucker 1120 upwardly and downwardly.

In use, a person separates the upper container portion 1116 from the lower container portion 1118. The person licks the outer surface of the candy sucker 1120. The fingergrip 1115 can be rotated to further extend the candy sucker 1120 relative to the lower container portion 1112.

Another embodiment of the candy sucker article 1210 according to the present invention is shown in FIGS. 16 and 17.

The candy sucker article 1210 includes a container 1212 having a lower container portion 1214 connected to an upper container portion 1216. The upper container portion 1216 can be removable from the lower container portion 1214, for example, by providing a snapfit connection or threaded connection. Alternatively, the upper container portion 1216 is substantially permanently connected to the lower container portion 1214. The upper container portion includes a sleeve 1216a having a through hole 1216b configured for receiving a sucker 1220 connected to a handle portion 1220a. The handle 1220a includes a stop 1220b and a ridge 1220c to provide a snap connection with the lid 1216. This embodiment allows for the quick connect and disconnect between the candy sucker and container 1212 to minimize the amount of effort needed to open the container 1212 and to provide convenience and use.

In use, a person grabs the handle 1220a and pulls upwardly to remove the candy sucker 1220 from the container 1212. A person licks the outer surface of the candy sucker 1220, and inserts the end through the through hole 1216b of the lid 1216 for storing same therein. The person then again removes the candy sucker 1220 from the container 1212, and licks same again.

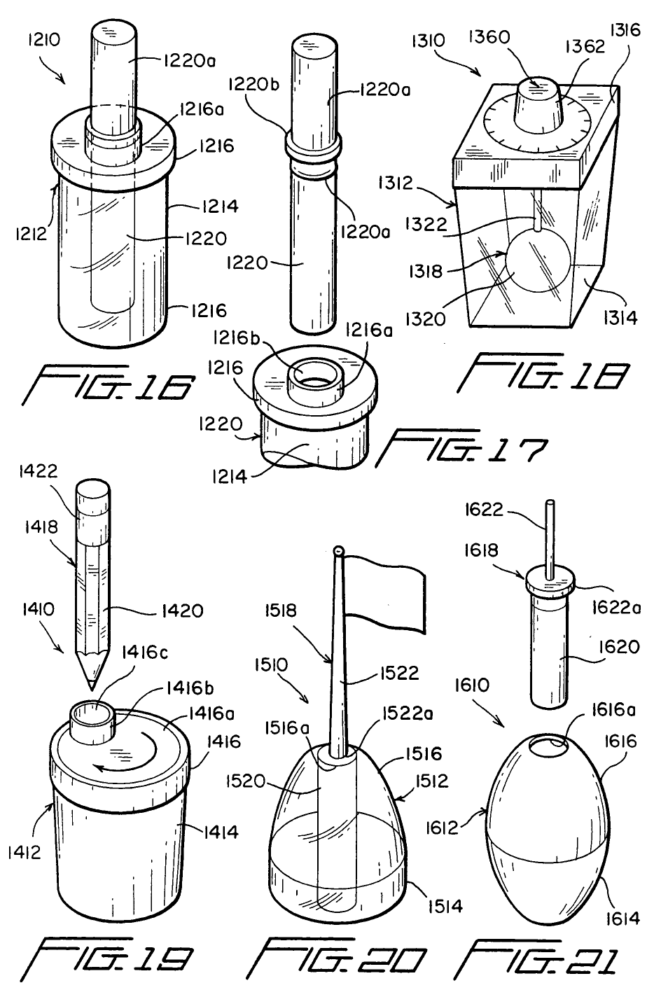

Another candy sucker article 1310 according to the present invention is shown in FIG. 18.

The candy sucker article 1310 includes a container 1312 having a lower container portion 1314 connected to an upper container portion or lid 1316. The candy sucker article 1310 is configured to simulate a lock or safe.

A rotating device 1360 having a fingergrip 1362 is provided on the lid 1316. A lollipop 1318 is disposed within the container 1312. The lollipop includes a hard candy portion 1320 connected to a stick portion 1322. The stick portion 1322 is connected to the rotating device 1360. For example, the fingergrip 1362 can be provided with a hole or aperture on the bottom thereof configured to receive the free end of the lollipop stick 1322. In use, a person removes the lid 1316 from the lower container portion 1314 and then licks the outer surface of the lollipop. The person then places the lollipop 1318 back into the lower container portion 1314 for storing same. The person then again removes the lollipop 1318 from the container 1312, and licks same.

Another embodiment of the candy sucker article 1410 according to the present invention is shown in FIG. 19.

The candy sucker article 1410 includes a container 1412 having a lower container portion 1414 connected to an upper container portion or lid 1416. The lid 1416 can be substantially permanently attached to the lower container portion 1414, or can be removably attached, for example, by providing a threaded connection or snapfit connection therebetween.

The candy sucker article 1410 is configured to simulate a pencil sharpener. The lid 1416 includes a rotatable lid portion 1416a provided with an upwardly extending sleeve 1416b having a through hole 1416c therein.

A lollipop 1418 configured to simulate a pencil is configured to fit through the through hole 1416c of the rotatable lid portion 1416a. The lollipop 1418 includes a hard candy portion 1420 and a stick portion 13422.

In use, the user licks the hard candy portion 1420 of the lollipop 1418, and then places the lower end of the lollipop 1418 through the through hole 1416c of the rotatable lid portion 1416a. The lollipop 1418 can be manipulated by the user so that the lollipop 1418 spins within the container 1412 the same or similar to a pencil sharpener. The user then withdraws the lollipop 1418 and then licks the hard candy portion 1420 of the lollipop 1418.

Another embodiment of the candy sucker article 1510 according to the present invention is shown in FIG. 20.

The candy sucker article 1510 includes a container portion 1512 having a lower container portion 1514 and an upper container portion or lid 1516. The upper container portion 1516 can be removably connected to the lower container portion 1514. A lollipop 1518 having a hard candy portion 1520 and a stick portion 1522 is removably connected to the lid 1516. For example, the stick portion 1522 is provided with a flange 1522a configured to snap fit into a through hole 1516a of the lid 1516. The lid 1516, for example, can be made of a see through plastic material (e.g. clear and colorless, clear and colored, clear and tinted, transparent and translucent) to allow viewing of the hard candy portion 1520 stored within the container portion 1512. Optionally, the lower container portion 1514 can also be made of see through plastic material. Further, the lid 1516 is shown dome-shaped, however, other shapes can be substituted therefore.

In use, a person grips the stick portion 1522 of the lollipop 1518 while gripping the container portion 1512, and pulls the lollipop 1518 from the container portion 1512. The person licks the outer surface of the hard candy portion 1520, and then reinserts the hard candy portion 1520 of the lollipop 1518 back into the container portion 1512 to store same. The person again removes the lollipop 1518 from the container portion 1512 to allow the person to lick the hard candy portion 1520 of the lollipop 1518.

Another embodiment of the candy sucker article 1610 according to the present invention is shown in FIG. 21.

The candy sucker article 1610 includes a container portion 1612 having a lower container portion 1614 and an upper container portion or lid 1616. The upper container portion 1616 can be removably connected to the lower container portion 1614. A lollipop 1618 having a hard candy portion 1620 and a stick portion 1622 is removably connected to the lid 1616. For example, the stick portion 1622 is provided with a flange 1622a configured to snap fit into a through hole 1616a of the lid 1616. The lid 1616, for example, can be made of a see through plastic material (e.g. clear and colorless, clear and colored, clear and tinted, transparent and translucent) to allow viewing of the hard candy portion 1620 stored within the container portion 3612. Optionally, the lower container portion 1614 can also be made of see through plastic material. Further, the container portion 1614 is shown as egg-shaped, however, other shapes can be substituted therefore.

In use, a person grips the stick portion 1622 of the lollipop 1618 while gripping the container portion 1612, and pulls the lollipop 1618 from the container portion 1612. The person licks the outer surface of the hard candy portion 1620, and then reinserts the hard candy portion 1620 of the lollipop back into the container portion 1612 to store same. The person again removes the lollipop 1618 from the container portion 1612 to allow the person to lick the hard candy portion 1620 of the lollipop 1618.

Another embodiment of the candy sucker article 1710 according to the present invention is shown in FIG. 22.

The candy sucker article 1710 includes a container portion 1712 having a lower container portion 1714 and an upper container portion or lid 1716. The upper container portion 1716 can be removably connected to the lower container portion 1714. The lower container portion 1714 is provided with a battery operated rotary mechanism or manually operated spring wind up mechanism configured to selectively drive a spindle 1714a of the lower container portion 1714 upon actuation of switch or button 1714b. The spring mechanism can be the same or similar to the spring mechanism shown and described for the embodiment shown in FIG. 25. A lollipop 1718 having a hard candy portion 1720 and a stick portion 1722 is connected to the rotating spindle 1714a of the lower container portion 1714. The lollipop 1718 and spindle 1714a can be configured to allow the lollipop 1718 to be removed from the spindle 1714a and then replaced. For example, the lower end of the stick portion 1722 is received within an aperture 1714c of the spindle 1714a for securely and removably connecting the lollipop 1718 to the spindle 1714a. A lower end of the lid 1716 is configured to connect to an upper end of the lower container portion 1714. For example, an inner surface of the lower end of the lid 1716 snap fits or interference fits with a flange 1714d of the lower container portion 1714. The removable lid 1716, for example, can be made of a see through plastic material (e.g. clear and colorless, clear and colored, clear and tinted, transparent and translucent) to allow viewing of the hard candy portion 1720 stored within the container portion 1712. Optionally, the lower container portion 1714 can also be made of see through plastic material to allow a person to view the battery operated rotating mechanism or spring wind up mechanism.

In use, a person removes the lid 1716 from the lower container portion 1714. The person licks the outer surface of the hard candy portion 1720. The person presses the button 1714b to cause the lollipop 1718 to spin while licking. The lid 1716 can be connected to the lower container portion 1714 to store the lollipop 1718.

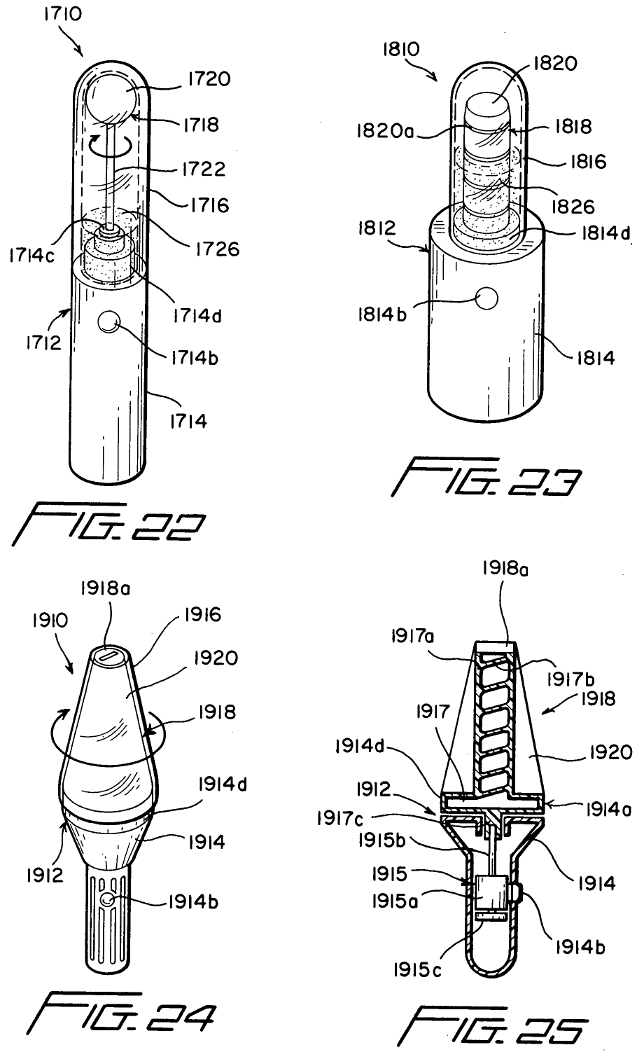

Another embodiment of the candy sucker article 1810 according to the present invention is shown in FIG. 23.

The candy sucker article 1810 includes a container portion 1812 having a lower container portion 1814 and an upper container portion or lid 1816. The upper container portion 1816 can be removably connected to the lower container portion 1814. The lower container portion 1814 is provided with a battery operated or manually operated spring wind up mechanism configured to selectively drive the lollipop 1818 of the lower container portion 1814 upon actuation of button 1814b. The spring mechanism is the same or similar to the spring mechanism shown and described for the embodiment shown in FIG. 25. A lollipop 1818 having a hard candy portion 1820 is connected to a rotating spindle located within the lower container portion 1814. The lollipop 1818 and internal spindle can be configured to allow the lollipop 1818 to be removed from the internal spindle and then replaced. For example, the lower end of the hard candy portion 1820 is received within an aperture of the internal spindle for securely and removably connecting the lollipop 1818 to the interior spindle. The hard candy portion 1820 is provided with a helical groove 1820a the same as or similar to a drill.

A lower end of the lid 1816 is configured to be connected to an upper end of the lower container portion 1814. For example, an inner surface of the lower end of the lid 1816 snap fits or interference fits with a flange 1814d of the lower container portion 1814. The removable lid 1816, for example, can be made of a see through plastic material (e.g. clear and colorless, clear and colored, clear and tinted, transparent and translucent) to allow viewing of the hard candy portion 1820 stored within the container portion 1812. Optionally, the lower container portion 1814 can also be made of see through plastic material to allow a person to view the spring wind up mechanism.

In use, a person removes the lid 1816 from the lower container portion 1814. The person licks the outer surface of the hard candy portion 1820 and presses the button 1814b to cause the lollipop 1818 to spin. The person then replace the lid 1816 to store the lollipop 1818.

Another embodiment of the candy sucker article 1910 according to the present invention is shown in FIGS. 24 and 25.

The candy sucker article 1910 includes a container portion 1912 having a lower container portion 1914 and an upper container portion or lid 1916. The upper container portion 1916 can be removably connected to the lower container portion 1914. The lower container portion 1914 is provided with a battery operated or manually operated wind up spring mechanism 1915 configured to selectively drive a spindle 1914a of the lower container portion 1914 upon actuation of switch or button 1914b. For example, the spring mechanism includes a housing 1915a provided with bearings for rotatably supporting shaft 1915b connected to spindle 1914a. Further, the housing is provided with a locking mechanism (e.g. escapement, latch or ratchet)configured to prevent rotation of the shaft 19015b in one direction (i.e. “driving” direction) while allowing substantially free rotation in an opposite direction. A helical spring 1915c is connected between the housing 1915a and shaft 1915b to apply a “driving” force to shaft 1915b when the helical spring 1915c is wound up. The button 1914b is configured to selectively release or trip the locking mechanism to allow the shaft 1915b to be driven by the helical spring 1915c, and in turn rotate the spindle 1914a and lollipop 1918. The lollipop 1918 includes a hard candy portion 19020 connected to the rotating spindle 1914a of the lower container portion 1914. For example, the hard candy portion 1920 is molded onto a plastic injection mold spindle 1914a.

The rotatable spindle 1914a can be a single piece plastic injection mold part. The rotatable spindle 1914a is provided with a downwardly extending flange 1917c configured for connection with shaft 1915b of the battery operated or manually operated wind up spring mechanism 1915. For example, the end of the shaft 1915b is keyed to fit within a keyed aperture molded in the lower end of the flange 1917c.

A lower end of the lid 1916 is configured to be connected to an upper end of the lower container portion 1914. For example, an inner surface of the lower end of the lid 1916 snap fits or interference fits with a flange 1914d of the lower container portion 1914. The removable lid 1916, for example, can be made of a see through plastic material (e.g. clear and colorless, clear and colored, clear and tinted, transparent and translucent) to allow viewing of the hard candy portion 1920 stored within the container portion 4012. Optionally, the lower container portion 1914 can also be made of see through plastic material to allow a person to view the battery operated or spring wind up mechanism.

In use, a person removes the lid 1916, and places the lollipop 1918 in his or her mouth. The person then presses the button 1914b to drive the spindle 1914a and rotate

Another embodiment of the candy sucker article 2010 according to the present invention is shown in FIG. 26.

The candy sucker article 2010 includes a container 2012 having a lower container portion 2014 connected to an upper container portion or lid 2016. The upper container portion 2016 is removably connected to the lower container portion 2014, for example, by providing a snapfit connection, twist or threaded connection therebetween. The upper container portion 2016 is provided with a handle portion 2017. A lollipop 2018 having a hard candy portion 2020 connected to a stick portion 2022 extends downwardly from the upper lid portion 2016.

The upper container portion 2016 is configured to twist or turn the lollipop 2018 both when disposed within the lower container portion 2014, and when removed from the lower container portion 2014. For example, the upper container portion 2016 is provided with a pull thread or string 2016a having a finger grip 2016b located at an end thereof. Preferably the upper container portion 2016 is spring loaded (e.g. with a spiral or helix shaped spring) configured so that when the pull string 2016a is pulled out, the pull string 2016a will retract automatically. In one embodiment, the lollipop 2018 does not rotate when the pull string 2016a is retracted, and in another embodiment the lollipop 2018 spins when the pull string is retracted (e.g. spins clockwise or counter-clockwise). In addition, the upper container portion 2016 can be configured to spin or not spin the lollipop when the pull string is being pulled out. In an alternative embodiment, the pull string is couple with a mechanism located within the upper lid portion 2016 that can wind up and spin the lollipop 2018 faster and faster with each pull (e.g. ratchet mechanism in combination with gyro). As another alternative, the pull string is coupled with a mechanism configured to wind up, and then be released upon disengaging a locking device, for example, by pressing a button 2016c configured to selectively spin the lollipop 2018.

In use, a person grabs the handle portion 2017 and pulls upwardly or twists same to remove the lollipop 2018 from the lower container portion 2014. A person licks the outer surface of the lollipop 2018, and inserts the lollipop 2018 into the lower container portion 2014. The person pulls out the pull string 2016a to spin the lollipop 2018 while licking.

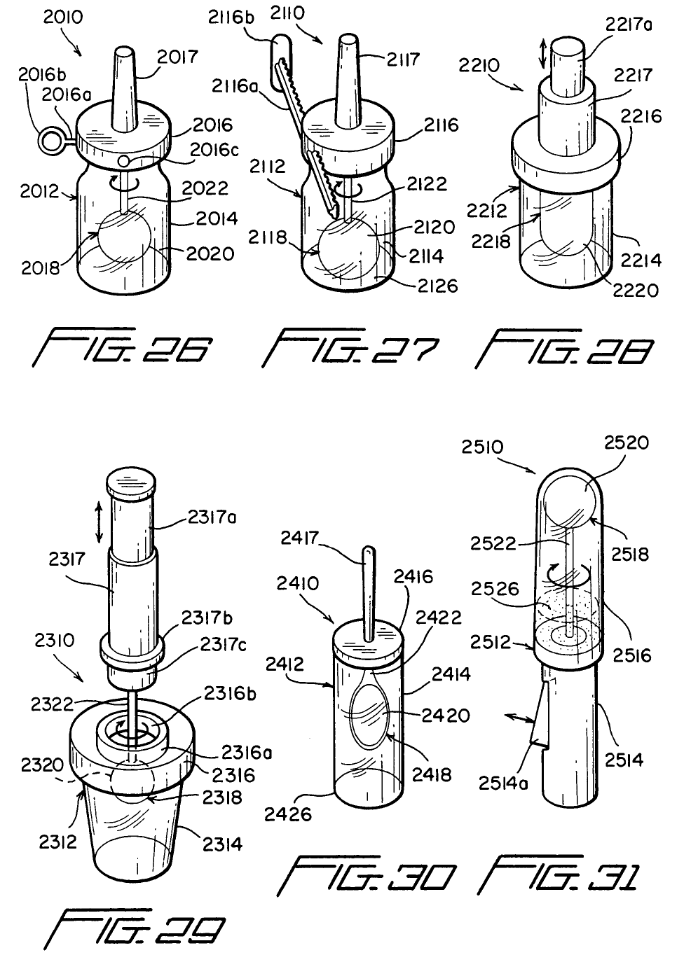

Another embodiment of the candy sucker article 2110 according to the present invention is shown in FIG. 27.

The candy sucker article 2110 includes a container 2112 having a lower container portion 2114 connected to an upper container portion or lid 2116. The upper container portion 2116 is removably connected to the lower container portion 2114, for example, by providing a snapfit connection, twist or threaded connection therebetween. The upper container portion 2116 is provided with a handle portion 2117. A lollipop 2118 having a hard candy portion 2120 connected to a stick portion 2122 extends downwardly from the upper lid portion 2116.

The upper container portion 2116 is configured to turn the lollipop 2118 both when disposed within the lower container portion 2114, and when removed from the lower container portion 2114. For example, the upper container portion 2116 is provided with a pull strip 2116a having a finger grip 2116b located at an end thereof. Preferably the upper container portion 2116 is provided with a gyro configured to rotate when the pull strip 2116a is pulled out of the upper lid portion 2116.

In use, a person grabs the handle portion 2117 and pulls upwardly or twists same to remove the lollipop 2118 from the lower container portion 2114. A person licks the outer surface of the lollipop 4518, pulls the pull strip 2116a to begin spinning the gyro and lollipop 2118, and continues to lick same. The person can then reinsert the lollipop 2118 into the lower container portion 2114 to store same.

Another embodiment of the candy sucker article 2210 according to the present invention is shown in FIG. 28.

The candy sucker article 2210 includes a container 2212 having a lower container portion 2214 connected to an upper container portion or lid 2216. The upper container portion 2216 is removably connected to the lower container portion 2214, for example, by providing a snapfit connection, twist or threaded connection therebetween. The upper container portion 2216 is provided with a handle portion 2217. A lollipop 2218 having a hard candy portion 2220 extends downwardly from the upper lid portion 2216.

The upper container portion 2216 is configured to rotate the lollipop 2218. For example, the upper container portion 2216 is provided with a spring loaded push button 2217a extending from the handle portion 2217. Preferably the upper container portion 2216 is configured so that the lollipop 2218 rotates when the button 2217b is depressed, and the lollipop 2218 rotates further when the spring loaded button 2217a is released.

Another embodiment of the candy sucker article 2310 according to the present invention is shown in FIG. 29.

The candy sucker article 2310 includes a container 2312 having a lower container portion 2314 connected to an upper container portion or lid 2316. The upper container portion 2316 is removably connected to the lower container portion 2314, for example, by providing a snapfit connection, twist or threaded connection therebetween. The upper container portion 2316 is provided with a handle portion 2317. A lollipop 2318 having a hard candy portion 2320 connected to an end of a stick portion 2322 extends downwardly from the handle portion 2317.

The handle portion 2317 is configured to rotate or twist the lollipop 2318 both when disposed within the lower container portion 2314, and when removed from the lower container portion 2314. For example, the upper container portion 2316 is provided with a spring loaded push button 2317a extending from the handle portion 2317. Preferably the handle portion 2317 is configured so that the lollipop 2318 rotates or twists when the button 2317a is depressed, and the lollipop 2318 further rotates or twists when the spring loaded button 2317a is released and automatically moves upwardly.

The upper lid portion 2316 is provided with an upwardly extending flange 2316a having a passageway 2316b extending therethrough. Further, the handle portion 2317 is provided with an outwardly extending radial flange 2317b and bottom end portion 2317c configured to releasably connect (e.g. snap fit connection or twist connection) with the flange 2316a and passageway 2316b of the upper lid portion 2316. This arrangement provides for a quick connect/disconnect coupling between the handle portion 2317 and the lower container portion 2314.

In use, a person grabs the handle portion 2317 and pulls upwardly or twists same to remove the lollipop 2318 from the lower container portion 2314. A person licks the outer surface of the lollipop 2318, and then depresses the push button 2317a to rotate or twist the lollipop 2318 while being licked. The person then places the lollipop 2318 into the lower container portion 2314 for storing same.

Another embodiment of the candy sucker article 2410 according to the present invention is shown in FIG. 30.

The candy sucker article 2410 includes a container 2412 having a lower container portion 2414 connected to an upper container portion or lid 2416. The upper container portion 2416 is removably connected to the lower container portion 2414, for example, by providing a snapfit connection, twist or threaded connection therebetween. The upper container portion 2416 is provided with a handle portion 2417. A lollipop 2418 having a hard candy portion 2420 connected to a stick portion 2422 extends downwardly from the upper lid portion 2416. The lollipop 2418 is configured to simulate a spoon.

In use, a person grabs the handle portion 2417 and pulls upwardly or twists same to remove the lollipop 2418 from the lower container portion 2414. A person licks the outer surface of the lollipop 2418, and reinserts the lollipop 2418 into the lower container portion 2414 for storing same.

Another embodiment of the candy sucker article 2510 according to the present invention is shown in FIG. 31.

The candy sucker article 2510 includes a container 2512 having a lower container portion 2514 connected to an upper container portion or lid 2516. The upper container portion 2516 is removably connected to the lower container portion 2514, for example, by providing a snap fit connection, twist or threaded connection therebetween. A lollipop 2518 having a hard candy portion 2520 connected to a stick portion 2522 extends upwardly from the lower container portion 2514.

The lower container portion 2514 is configured to twist or turn the lollipop 2518 both when disposed within the lower container portion 2514, and when removed from the lower container portion 2514. For example, the lower container portion 2514 is provided with a battery operated mechanism or spring loaded trigger or button 2514a. When the trigger or button 2514a is pushed in, a manually operated mechanism located within the lower container portion 2514 rotates the lollipop 2518. This step can be repeated to rotate the lollipop faster and faster.

In use, a person removes the upper container portion 2516 from the lower container portion 2514, and then licks the lollipop 2518 while activating the trigger or button 2514a to automatically or manually cause the lollipop 2518 to rotate. The person can replace the upper container portion 2516 for storing the lollipop 2518.

What is claimed is:

1. A candy sucker device, comprising:
a container; and
a candy sucker connected to said container, said container configured to manually rotate said candy sucker.

2. A device according to claim 1, wherein said sucker is a lollipop defined by a piece of hard candy disposed on an end of a stick.

3. A device according to claim 2, wherein said stick extends through a wall portion of said container and is manually rotatable relative to said container.

4. A device according to claim 3, wherein said container includes a removable closure, and said stick of said lollipop extends through a wall portion of said closure.

5. A device according to claim 4, wherein said closure is one selected from the group consisting of cap, lid, stopper and plug.

6. A device according to claim 1, including a manually rotary mechanism connected to said candy sucker and disposed within said container, said rotary mechanism configured to manually rotate said candy sucker relative to said container.

7. A device according to claim 6, wherein said manual rotary mechanism extends through a wall portion of said container.

8. A device according to claim 7, wherein said container includes a removable closure, and said manual rotary mechanism extends through a wall portion of said closure.

9. A device according to claim 7, wherein said manual rotary mechanism includes a finger grip portion located external to said container.

10. A device according to claim 6, wherein said candy sucker is molded onto said manual rotary device.

11. A device according to claim 6, wherein said candy sucker is a lollipop defined by a piece of hard candy located on an end of a stick, said stick being connected to said manual rotary device.

12. A device according to claim 10, wherein said manual rotary mechanism is a spindle extending through a wall portion of said container.

13. A device according to claim 7, wherein said container includes a removable closure, and said spindle extends through a wall portion of said closure.

14. A device according to claim 1, including a manual drive device configured for rotating said sucker.

15. A device according to claim 14, wherein said manual drive device is configured to be manually wound up.

16. A device according to claim 15, wherein said drive device is configured to store winding energy.

17. A candy sucker device, comprising:
a container configured to store a candy sucker;
a candy sucker stored within said container; and
a manual rotary device connected to said container, said manual rotary mechanism including a rotating portion connected to said candy sucker and configured to rotate relative to said container, whereby said candy sucker is manually rotated within said container.

18. A device according to claim 17, herein said container is configured to be opened and closed to said candy sucker to be selectively accessed.

19. A device according to claim 18, wherein said candy sucker is configured to selectively extend out from said container.
